(19) United States
(12) Patent Application Publication
(10) Pub. No.: US 2014/0036163 A1
(43) Pub. Date: Feb. 6, 2014

(54) System and Method for Protecting a Monitor

(71) Applicants: Jason Michael Avent, Canyon, TX (US); Emily Anna Wieck, Dawn, TX (US)

(72) Inventors: Jason Michael Avent, Canyon, TX (US); Emily Anna Wieck, Dawn, TX (US)

(73) Assignee: AGRI SHEILD, LLC, Canyon, TX (US)

(21) Appl. No.: 13/564,716

(22) Filed: Aug. 1, 2012

(51) Int. Cl. H04N 5/64

(52) U.S. Cl. 348/842; 348/E05.128

(57) ABSTRACT

A monitor cover is disclosed. Said monitor cover comprises a screen cover portion having a first side and a second side, an opening, and a binding. Said screen cover portion is capable of removably covering a screen of a monitor system. Said opening is capable of stretching over a portion of said monitor system. Said binding is capable of holding said screen cover portion of said monitor cover over said screen of said monitor system.

### BACKGROUND

This disclosure relates generally to a system and method for protecting a monitor system. Said monitor systems can be used within one or more vehicles for a variety of tasks such as navigation and instrument management. However, due to working conditions of said one or more vehicles, said monitor systems can be exposed to environmental hazards.

Previous systems for protecting said monitor systems comprise rudimentary approaches such as draping a towel over said monitor, removing said monitor from said vehicle between uses, and/or installing a visor over said monitor.

Mr. Trihn (U.S. patent application Ser. No. 12/384,355) discloses a visor and an attachment means for attaching said visor to a GPS unit. Trihn's visor is largely designed to cast a shadow over a monitor of said GPS unit. Said shadow does protect said screen from excessive light but does not protect said GPS unit from other environmental hazards.

None of the above inventions and patents, taken either singularly or in combination, is seen to describe the instant disclosure as claimed. Accordingly, an improved system and method for protecting a monitor system would be advantageous.

### SUMMARY

A monitor cover system and method are disclosed. Said monitor cover system comprises a monitor cover. Said monitor cover comprises a screen cover portion having a first side and a second side, an opening, and a binding. Said screen cover portion is capable of removably covering a screen of a monitor system. Said opening is capable of stretching over a portion of said monitor system. Said binding is capable of holding said screen cover portion of said monitor cover over said screen of said monitor system.

Said monitor covering method comprising attaching a monitor cover to a monitor system by: stretching a back opening of said monitor cover around said monitor system, sliding said back opening around a portion of said monitor system, and attaching said back opening of said monitor cover around said monitor system.

### BRIEF DESCRIPTION OF THE DRAWINGS

FIGS. 1A and 1B illustrate a perspective overview of a vehicle having a monitor system.

FIGS. 2A, 2B, 2C and 2D illustrate an elevated top view, front view, side view, and back view of monitor system.

FIGS. 3A and 3B illustrate a front perspective overview and a rear perspective overview of a monitor cover attached to monitor system.

FIGS. 4A, 4B, 4C and 4D illustrate an elevated top view, front view, side view, and back view of said monitor cover and monitor system 102.

FIG. 4E illustrates an elevated back view of said monitor cover with one or more straps.

FIG. 5A illustrates a perspective overview of said monitor system and a cross-section view of monitor cover.

FIGS. 5B and 5D illustrate two embodiments of a rear perspective cross-section overview of said monitor cover and binding, with said monitor system.

FIG. 5C illustrates a simplified elevated cross-section view of said outer portion and said inner portion.

FIG. 5B illustrates an embodiment of binding having an outer portion and an inner portion.

FIG. 5D illustrates an embodiment of said monitor cover where said binding comprises a uniform member and binding attaches to said back of said monitor cover.

FIGS. 6A, 6B, 6C, 6D and 6E illustrate a series of views illustrating of a method of constructing said monitor cover.

FIG. 6A illustrates an elevated overview of said one or more side portions of said monitor cover before assembly.

FIG. 6B illustrates a perspective overview of said one or more side portions of said monitor cover with said front unattached.

FIG. 6C illustrates a perspective overview of said one or more side portions of said monitor cover with said front attaching.

FIGS. 6D and 6E illustrate a perspective overview of said one or more side portions of said monitor cover with said front attached.

FIGS. 7A and 7B illustrate a front perspective overview and a rear perspective overview of a monitor cover attached to monitor system.

FIGS. 8A and 8B illustrate an elevated front view, side view, and top view of said monitor cover.

FIG. 9 illustrates a perspective front overview of said monitor cover comprising a flap catch.

FIGS. 10A, 10B, 10C, 10D and 10E illustrate series of views illustrating of a method of constructing said monitor cover.

FIG. 10A illustrates an elevated overview of said front comprising said window and said flap.

FIG. 10B illustrates a perspective overview of said one or more side portions of said monitor cover with said front unattached.

FIG. 10C illustrates a perspective overview of said one or more side portions of said monitor cover with said front attaching.

FIGS. 10D and 10E illustrate a perspective overview of said one or more side portions of said monitor cover with said front attached.

FIG. 11 illustrates a perspective overview of a monitor cover and said monitor system.

FIGS. 12A, 12B, 12C and 12D illustrate an elevated front view, and an elevated side view, a perspective overview and a perspective lower view of said monitor cover covering said monitor system.

### DETAILED DESCRIPTION

Described herein is a system and method for protecting a monitor system. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

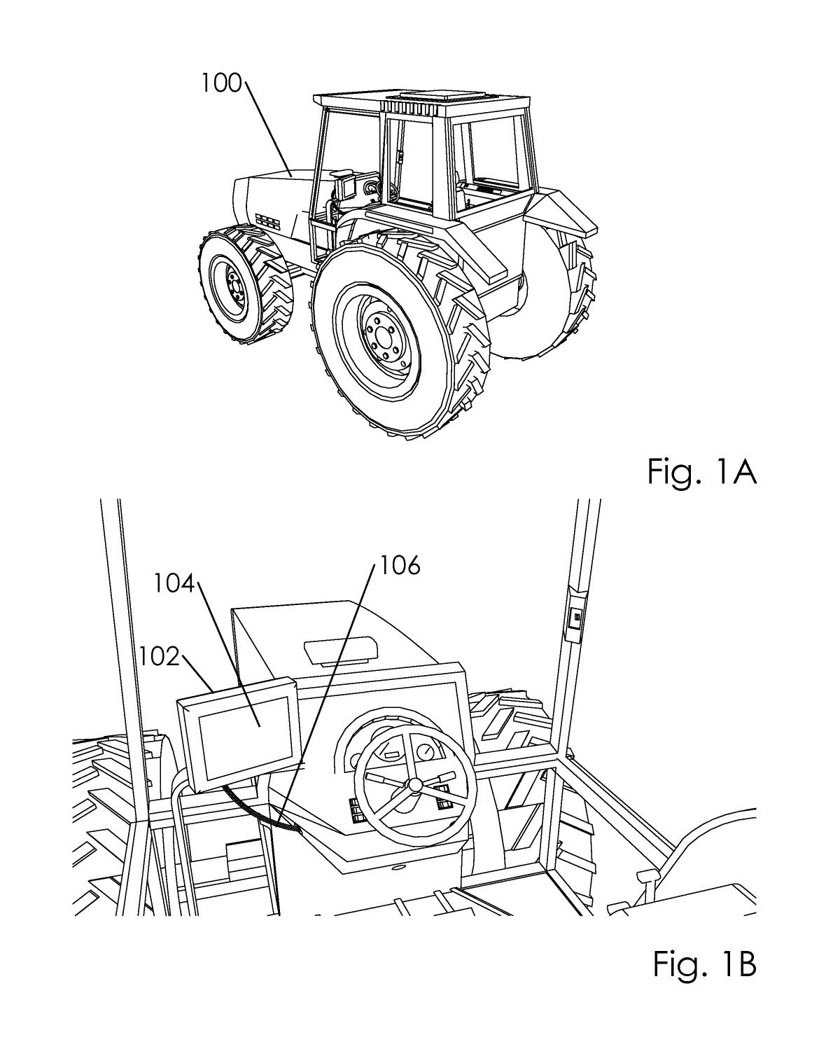

FIGS. 1A and 1B illustrate a perspective overview of a vehicle 100 having a monitor system 102. Monitor system 102 can comprise a screen 104. In one embodiment, monitor system 102 can attach to vehicle 100 through one or more wires 106.

In one embodiment, monitor system 102 can be used for navigation and instrument management. In one embodiment, vehicle 100 can comprise a tractor, a construction vehicle, a boat, a military vehicle, an airplane or similar. In one embodiment, vehicle 100 can be referred to as “precision vehicle”; wherein, said precision vehicle requires instrumentation and navigation feedback for a more optimal operation. In one embodiment, vehicle 100 with monitor system 102 can be useful within the agricultural and construction industries. In one embodiment, monitor system 102 can comprise an instrument useful for tracking functions and statistics of vehicle 100 such as a location, a speed, a distribution of chemicals, a distribution of fertilizers, a harvesting process of crops, an engine status, a fuel status, a number of hours in use, one or more finished tasks, one or more future tasks, a remote data, and similar.

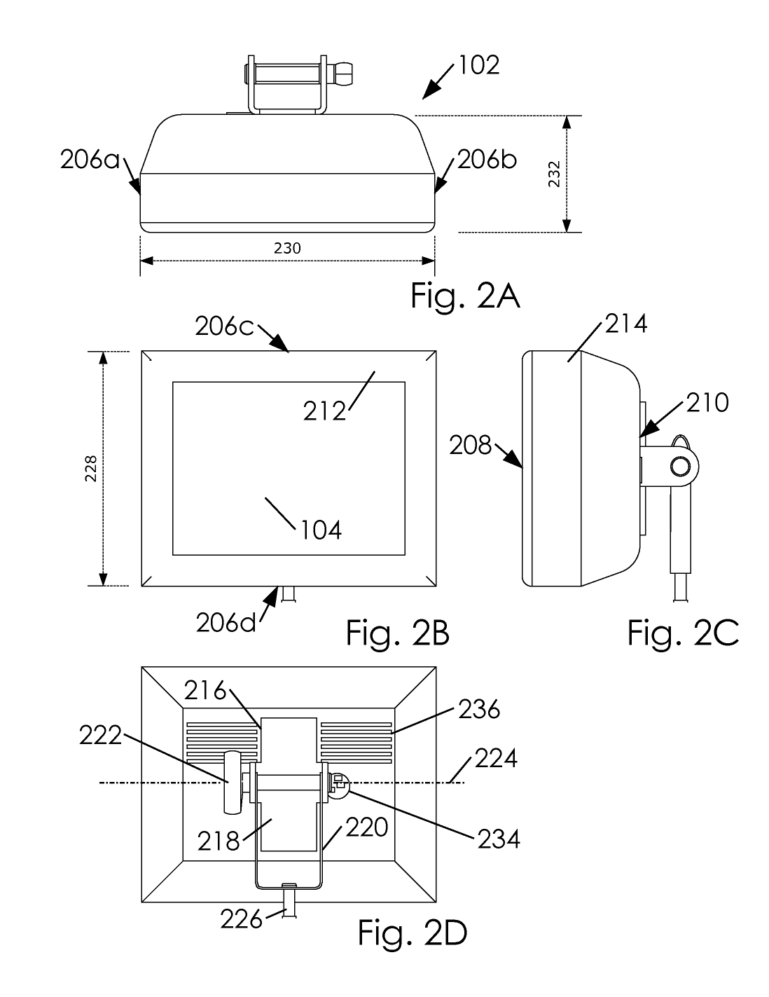

FIGS. 2A, 2B, 2C and 2D illustrate an elevated top view, front view, side view, and back view of monitor system 102. Monitor system 102 can comprise one or more edges. Said one or more edges of monitor system 102 can comprise a first side edge 206a, a second side edge 206b, a top edge 206c and a bottom edge 206d. Monitor system 102 can comprise a front 208 and a back 210. Monitor system 102 can comprise a screen bezel 212 and a shell 214.

In one embodiment, monitor system 102 can be exposed to one or more environmental hazards capable of harming said monitor system 102. In one embodiment, said environmental hazards can comprise sunlight, UV damage, dust, pests, operator errors, spills and similar hazards. In one embodiment, pests (such as flies) can land on sensitive equipment, such as monitor system 102, and leave behind a harmful film capable of disabling said monitor system 102. As is common in the field, in one embodiment, screen 104 can comprise a touchscreen capable of human machine interfacing by touch input and video output. In such an embodiment, screen 104 can become unresponsive after exposure to said one or more environmental hazards.

In one embodiment, a visual output from said screen 104 can become washed out with excessive light exposure. Likewise, in one embodiment, dust can accumulate on monitor system 102 if uncovered.

In one embodiment, monitor system 102 can attach to vehicle 100 with a mounting assembly 216. Mounting assembly 216 can comprise a bracket 218, a mount 220 and a grip 222. In one embodiment, mount 220 can articulate relative to bracket 218 about an axis 224. In one embodiment, mount 220 and mounting assembly 216 can be held in a configuration relative to one another by tightening said grip 222. In one embodiment, bracket 218 can attach to back 210 of monitor system 102. In one embodiment, mount 220 can attach to vehicle 100 with a screw assembly 226.

Monitor system 102 can comprise a height 228, a width 230, and a depth 232.

Monitor system 102 can comprise one or more wire sockets 234. In one embodiment, one or more wire sockets 234 can receive one or more wires 106. In one embodiment, one or more wires 106 can transmit power (such as electricity), data (such as a navigation signal from an antenna or telemetry data of vehicle 100), sensor readings, video inputs, and/or similar.

Monitor system 102 can comprise one or more vents 236. In one embodiment, said one or more vents 236 can comprise air vents capable of ventilating an interior portion of monitor system 102. In one embodiment, one or more vents 236 can be on said back 210 of monitor system 102. In one embodiment, one or more vents 236 can be at one or more of said one or more edges of monitor system 102.

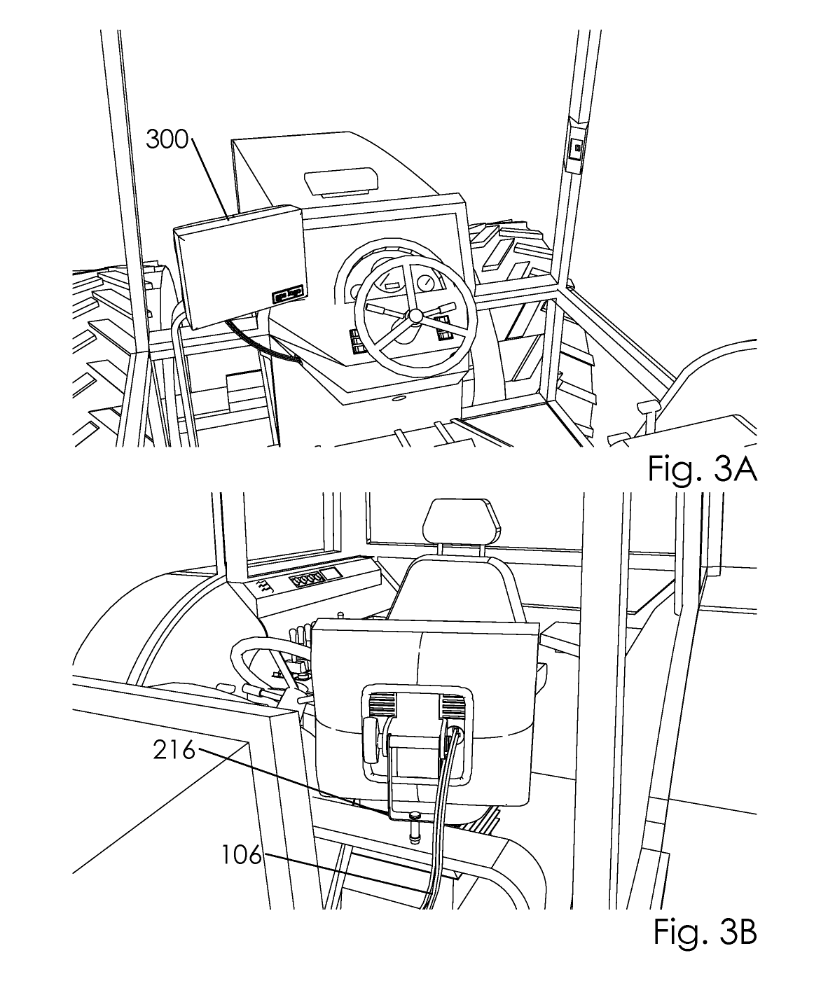

FIGS. 3A and 3B illustrate a front perspective overview and a rear perspective overview of a monitor cover 300 attached to monitor system 102. In one embodiment, monitor cover 300 can cover a portion of monitor system 102 without interfering with mounting assembly 216, a portion of said one or more wires 106 and/or a portion of said one or more vents 236.

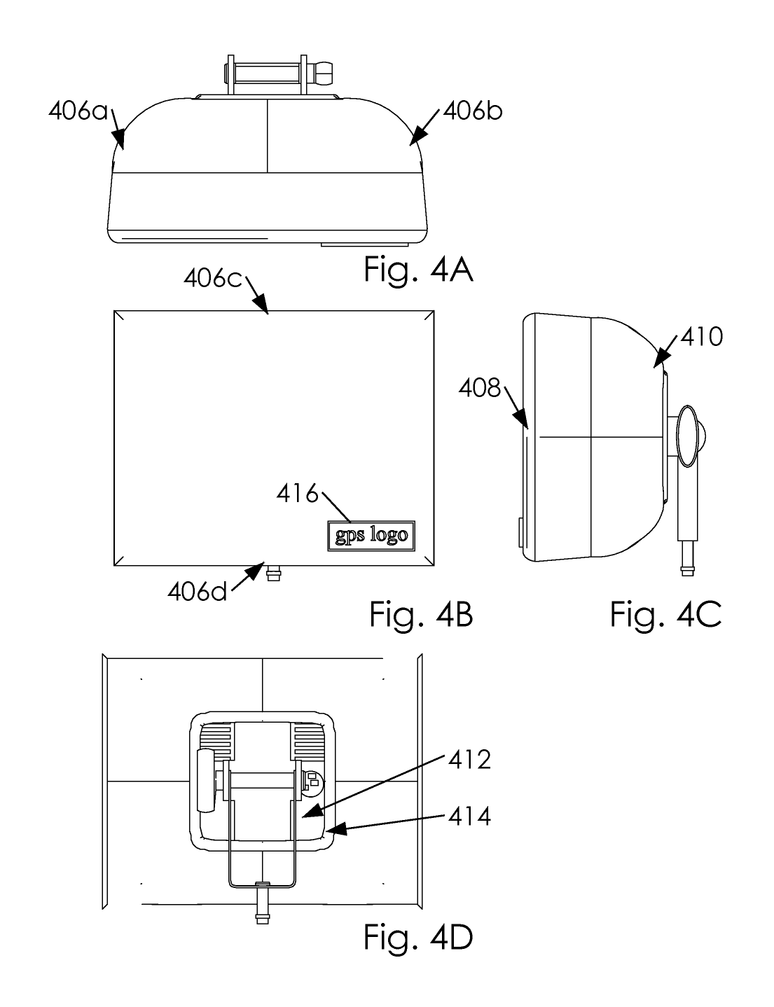

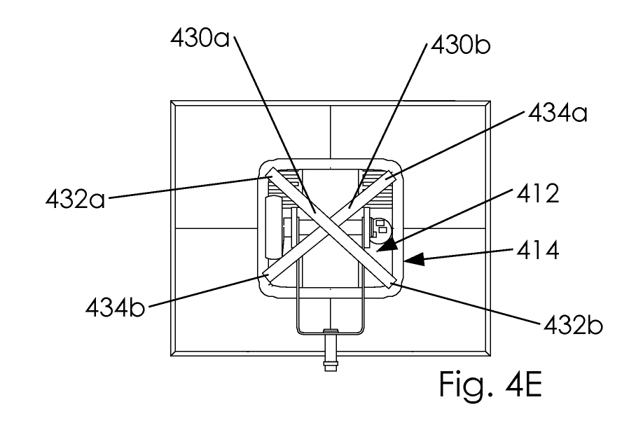

FIGS. 4A, 4B, 4C and 4D illustrate an elevated top view, front view, side view, and back view of said monitor cover 300 and monitor system 102. In one embodiment, monitor cover 300 can wrap around a portion of monitor system 102. In one embodiment, monitor cover 300 can protect monitor system 102 from said environmental hazards. In one embodiment, monitor cover 300 can cover said screen 104. In one embodiment, monitor cover 300 can protect front 208, said one or more edges of monitor system 102, and a portion of back 210 of monitor system 102.

Monitor cover 300 can comprise one or more side portions. Said one or more side portions of said monitor cover 300 can comprise a first side portion 406a, a second side portion 406b, a top side portion 406c and a bottom side portion 406d. Monitor cover 300 can comprise a front 408 and a back 410. In one embodiment, monitor cover 300 can comprise a back opening 412. In one embodiment, a portion of mounting assembly 216, and/or one or more wires 106 can pass through back opening 412. In one embodiment, a portion of said one or more vents 236 can be exposed through said back opening 412. In one embodiment, said one or more side portions of said monitor cover 300 can be pulled tight around said one or more edges of monitor system 102 by pulling said binding 414 closed.

In one embodiment, attaching said monitor cover 300 to monitor system 102 can comprise: stretching said binding 414 and expanding said back opening 412, sliding said back opening 412 around a portion of monitor system 102, and releasing said binding 414. In one embodiment, sliding said back opening 412 around said portion of said monitor system 102 can comprise sliding said back opening 412 around front 208 and a portion of said one or more edges of monitor system 102.

In one embodiment, monitor cover 300 can wrap around monitor system 102. In one embodiment, front 408 can be substantially flat to cover said screen 104 and front 208 of monitor system 102. In one embodiment, said one or more side portions of said monitor cover 300 can be held against shell 214 of monitor system 102.

In one embodiment, monitor cover 300 can comprise a logo 416. In one embodiment, logo 416 can be attached to front 408 of monitor system 102. In one embodiment, logo 416 can be screen printed to front 408 of monitor system 102.

In one embodiment, binding 414 can lack an elastic quality; wherein, monitor cover 300 can be held on monitor system 102 with a strap mechanism capable of releasably holding back opening 412 closed.

FIG. 4E illustrates an elevated back view of said monitor cover 300 with one or more straps. In one embodiment, said one or more straps can comprise a first strap 430a and a second strap 430b. In one embodiment, said 430a can comprise a first end 432a and a second end 432b. In one embodiment, said second strap 430b can comprise a first end 434a and a second end 434b. In one embodiment, said one or more straps can cross said back opening 412 and hand hold said monitor cover 300 around said monitor system 102. In one embodiment, said first end 434a and first end 432a can be attached to said binding 414. In one embodiment, said first end 432a and second end 432b can be releaseably attached to said binding 414. Thus, in one embodiment, said one or more straps can releaseably attach said monitor cover 300 to said monitor system 102. In one embodiment, said one or more straps can be used instead of said binding 414. For example, in one embodiment, said one or more straps can hold said monitor cover 300 around said monitor system 102 without any elastic within said binding 414 or without said binding 414 at all. Said one or more straps need not cross one another at said back opening 412 (as illustrated), they only need to create a secure hold around said back opening 412.

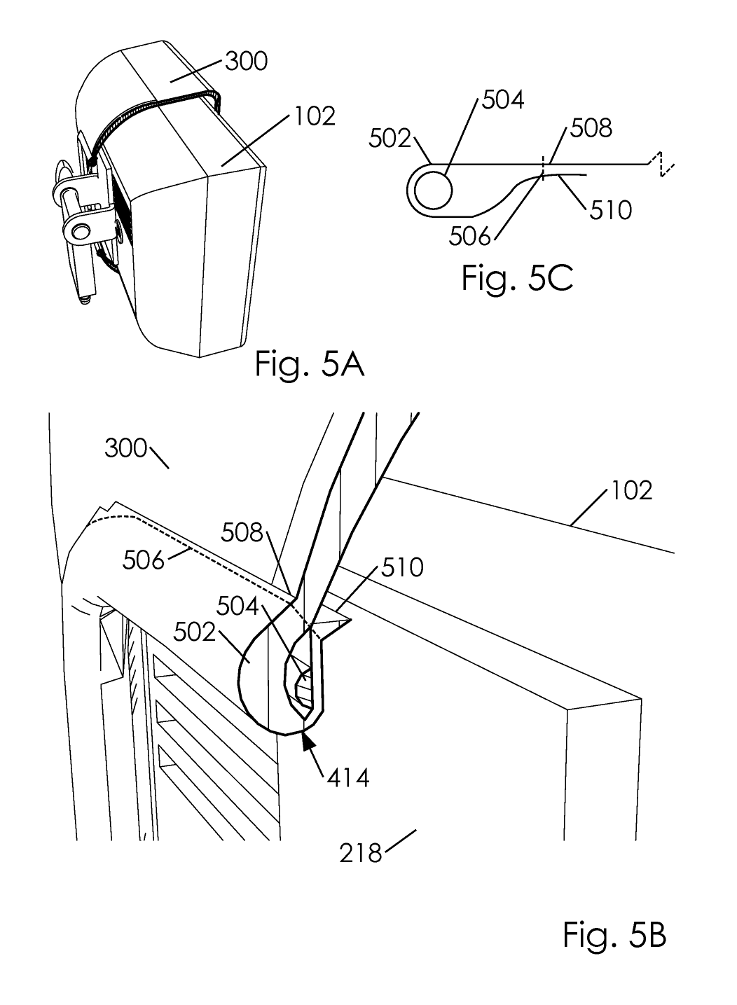

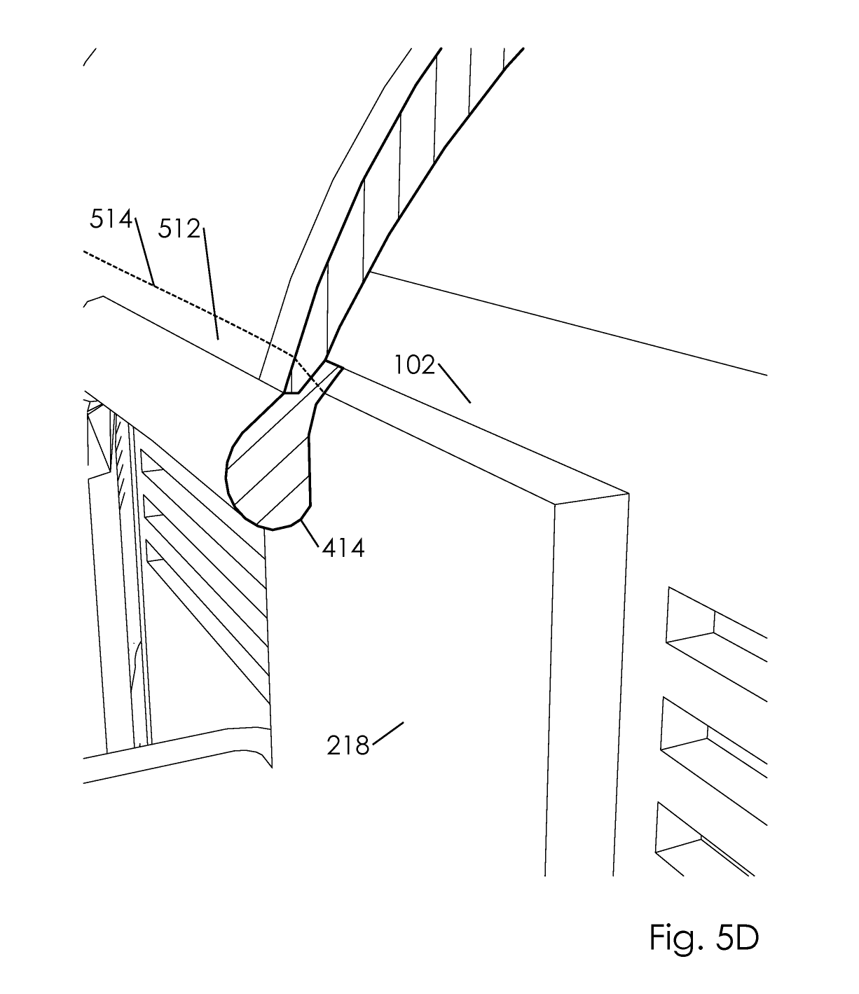

FIG. 5A illustrates a perspective overview of said monitor system 102 and a cross-section view of monitor cover 300. FIGS. 5B and 5D illustrate two embodiments of a rear perspective cross-section overview of said monitor cover 300 and binding 414, with said monitor system 102. FIG. 5C illustrates a simplified elevated cross-section view of said outer portion 502 and said inner portion 504.

FIG. 5B illustrates an embodiment of binding 414 having an outer portion 502 and an inner portion 504. In one embodiment, sewing said inner portion 504 within said outer portion 502 can comprise folding a portion of said outer portion 502 around said inner portion 504 and stitching said outer portion 502 back to itself with a stitch 506. In one embodiment, outer portion 502 can comprise a portion of back 410. Said outer portion 502 can comprise a first end 508 and a second end 510. In one embodiment, said second end 510 can comprise an edge of a fabric comprising said back 410 of said monitor cover 300. In one embodiment, said outer portion 502 can attach to said inner portion 504 by sewing said outer portion 502 around said inner portion 504. In one embodiment, sewing said outer portion 502 around said inner portion 504 can comprise: pulling said second end 510 of said outer portion 502 over said inner portion 504; wrapping said second end 510 of said outer portion 502 underneath, behind and around said inner portion 504; and sewing said stitch 506 through said first end 508 and said second end 510. In one embodiment, sewing said stitch 506 through said first end 508 and said second end 510 can hold said outer portion 502 around said inner portion 504.

In one embodiment, a circumference of said back opening 412 can be minimized by tightening said inner portion 504 within said outer portion 502. In one embodiment, minimizing said circumference of said back opening 412 can contribute to holding said monitor cover 300 around monitor system 102. In one embodiment, inner portion 504 can comprise an elastic cord. In one embodiment, inner portion 504 can comprise a drawstring.

FIG. 5D illustrates an embodiment of said monitor cover 300 where said binding 414 comprises a uniform member and binding 414 attaches to said back 410 of said monitor cover 300. In one embodiment, binding 414 can comprise an elastic band. In one embodiment, binding 414 can attach to a back edge 512 of said monitor cover 300. In one embodiment, back edge 512 can comprise an edge of a fabric comprising said back 410 of said monitor cover 300. In one embodiment, attaching said binding 414 to said back 410 can comprise sewing said binding 414 to said back edge 512 with a stitch 514. In one embodiment, sewing binding 414 to said back edge 512 can comprise sewing said stitch 514 through a portion of said binding 414 and said back edge 512 and around said circumference of said back opening 412.

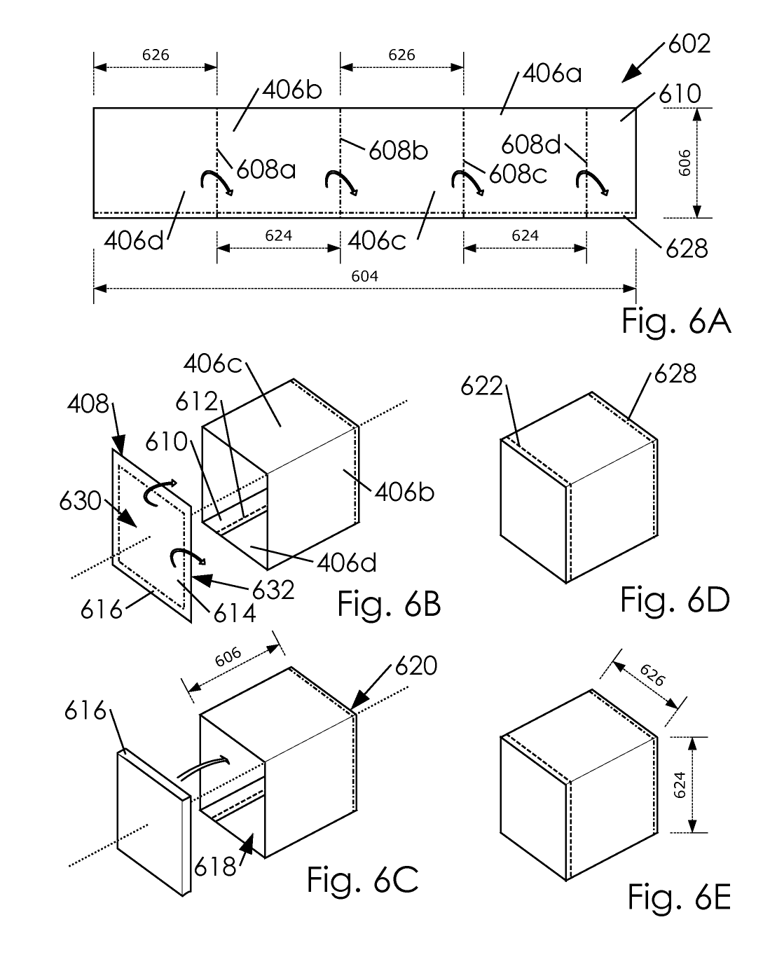

FIGS. 6A, 6B, 6C, 6D and 6E illustrate a series of views illustrating of a method of constructing said monitor cover 300. FIG. 6A illustrates an elevated overview of said one or more side portions of said monitor cover 300 before assembly. FIG. 6B illustrates a perspective overview of said one or more side portions of said monitor cover 300 with said front 408 unattached. FIG. 6C illustrates a perspective overview of said one or more side portions of said monitor cover 300 with said front 408 attaching. FIGS. 6D and 6E illustrate a perspective overview of said one or more side portions of said monitor cover 300 with said front 408 attached.

In one embodiment, said one or more side portions of said monitor cover 300 can comprise four portions of a side fabric 602. Side fabric 602 can comprise a width 604 and a length 606. In one embodiment, one or more side portions of said monitor cover 300 can comprise said side fabric 602 folded at a plurality of bent edges. Said plurality of bent edges of side fabric 602 can comprise a first bent edge 608a, a second bent edge 608b, a third bent edge 608c and a fourth bent edge 608d. In one embodiment, side fabric 602 can comprise said one or more side portions of said monitor cover 300 and a flap 610. In one embodiment, constructing said one or more side portions of said monitor cover 300 can comprise folding said side fabric 602 at said plurality of bent edges of side fabric 602, and sewing a portion of flap 610 to a portion of bottom side portion 406d with a stitch 612. In one embodiment, said one or more side portions of said monitor cover 300 can comprise a substantially rectangular sleeve. In one embodiment, said one or more side portions of monitor cover 300 can comprise a uniform material (as described here to be said side fabric 602). In one embodiment, said monitor cover 300 can comprise said uniform material (such as a canvas material). Said one or more side portions of monitor cover 300 can comprise four parts of said uniform material.

In one embodiment, front 408 of said monitor cover 300 can comprise a substantially rectangular textile having a central portion 614 and an edge portion 616. In one embodiment, said one or more side portions of said monitor cover 300 can comprise a first open end 618 and a second open end 620. In one embodiment, front 408 can attach to and cover said first open end 618 of said one or more side portions of said monitor cover 300. In one embodiment, attaching said front 408 to said first open end 618 can comprise: aligning said front 408 with said first open end 618, sliding a portion of said edge portion 616 inside of said first open end 618, and attaching said edge portion 616 to said one or more side portions of said monitor cover 300 with a stitch 622.

In one embodiment, second side portion 406b and first side portion 406a can comprise a height 624. In one embodiment, top side portion 406c and bottom side portion 406d can comprise a width 626. In one embodiment, height 624 and width 626 can be altered in order that said monitor cover 300 can fit a variety of monitor systems 102.

Side fabric 602 can comprise a bottom edge 628. In one embodiment, said bottom edge 628 can comprise said back edge 512 and/or said outer portion 502, as discussed infra.

In one embodiment, side fabric 602 and front 408 can comprise a coated polyester, flannel, canvas, cotton based material, a ballistic nylon or similar. In one embodiment, front 408 can comprise a first side 630 and a second side 632. In one embodiment, said first side 630 can comprise a portion of said front 408 facing outside of said monitor cover 300, and said second side 632 can comprise a portion of said front 408 facing inward within said monitor cover 300. In one embodiment, second side 632 can comprise a soft material (i.e., non-abrasive) capable of protecting said screen 104 of said monitor system 102. In one embodiment, said soft material can comprise a synthetic fleece.

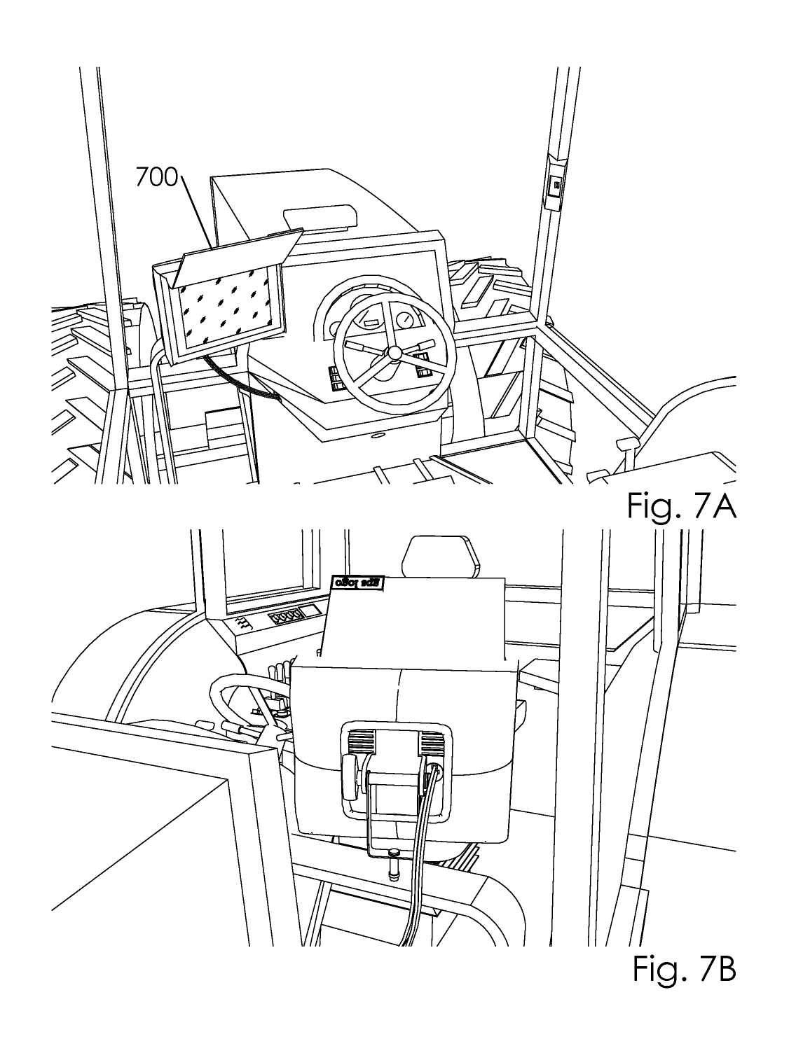

FIGS. 7A and 7B illustrate a front perspective overview and a rear perspective overview of a monitor cover 700 attached to monitor system 102.

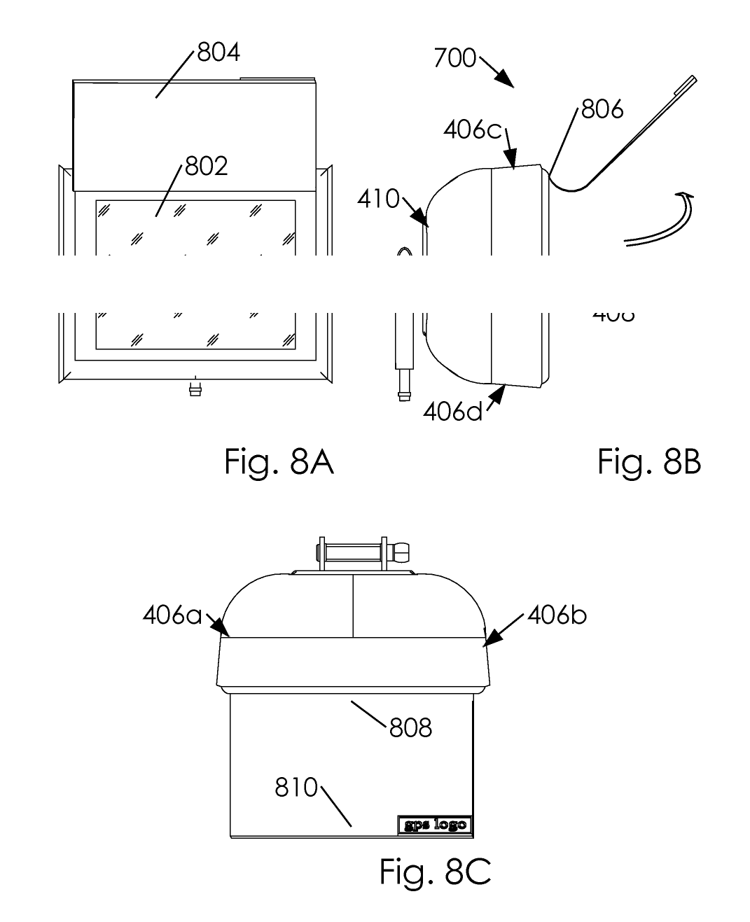

FIGS. 8A and 8B illustrate an elevated front view, side view, and top view of said monitor cover 700. In one embodiment, said monitor system 102 can be used without removing said monitor cover 700. For example, in one embodiment, monitor cover 700 can comprise a window 802 and a flap 804. In one embodiment, said monitor cover 700 can comprise said monitor cover 300 further comprising said window 802 and/or said flap 804. In one embodiment, flap 804 can attach to monitor cover 700 at a hinge 806. In one embodiment, flap 804 can comprise a top portion 808 and a bottom portion 810. In one embodiment, hinge 806 can comprise a textile connection between top portion 808 and said top side portion 406c of said monitor cover 700. In one embodiment, flap 804 can rotate freely on hinge 806. In one embodiment, window 802 can comprise a substantially transparent material.

In one embodiment, flap 804 can comprise an open-configuration and a closed-configuration; wherein, said open-configuration can comprise flap 804 rotated back on hinge 806 to expose window 802, and said closed-configuration can comprise flap 804 rotated forward on hinge 806 to cover window 802 with flap 804.

In one embodiment, window 802 can comprise a plastic. In one embodiment, screen 104 can comprise a touchscreen and window 802 is capable of transmitting a touch input to monitor system 102 through window 802. In another embodiment, monitor cover 700 can comprise flap 804 without said window 802; wherein, window 802 is replaced by an aperture capable of exposing said screen 104.

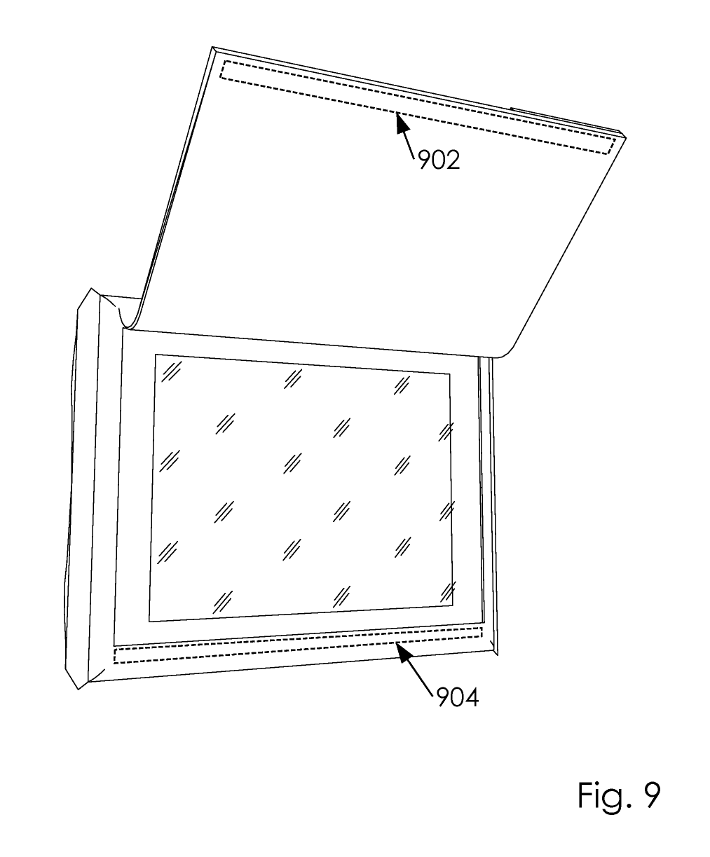

FIG. 9 illustrates a perspective front overview of said monitor cover 700 comprising a flap catch. In one embodiment, said flap catch can comprise a first portion 902 and a second portion 904. In one embodiment, first portion 902 can attach to and detach from said second portion 904; wherein, first portion 902 can releasably hold said flap 804 in said closed-configuration. In one embodiment, said flap catch can comprise corresponding portions of a hook-and-loop fastener assembly. In one embodiment, said flap catch can comprise a pair of magnets. In one embodiment, first portion 902 can be attached to and/or sewn within bottom portion 810 of flap 804. In one embodiment, second portion 904 can be attached to or sewn within front 408 near bottom side portion 406d. In one embodiment, with monitor cover 700 in said closed-configuration, first portion 902 and second portion 904 can line up and hold one another.

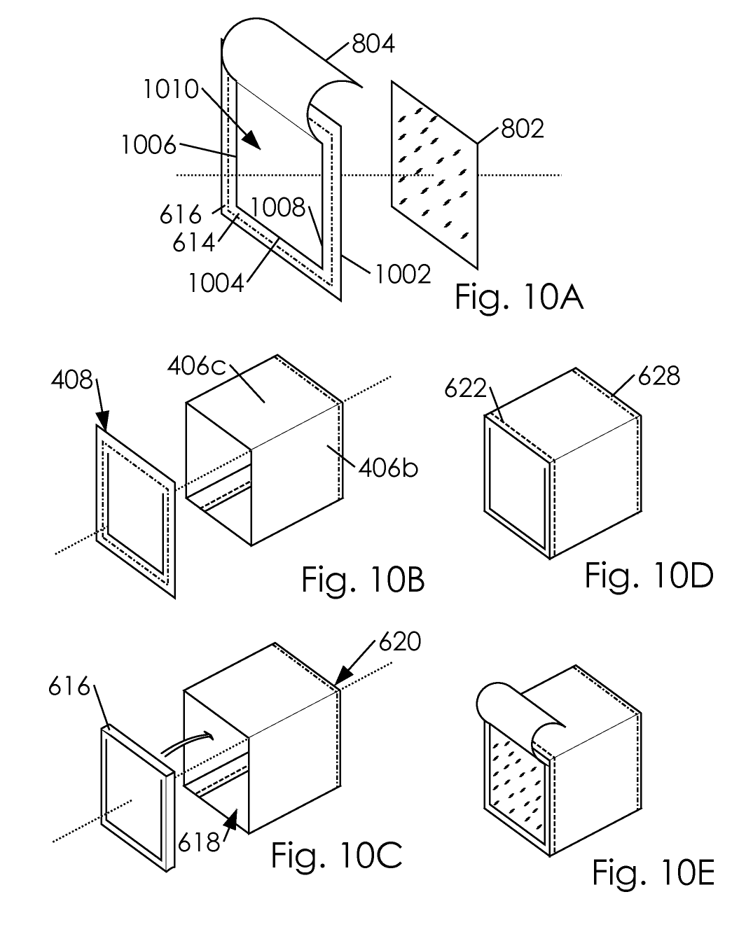

FIGS. 10A, 10B, 10C, 10D and 10E illustrate series of views illustrating of a method of constructing said monitor cover 700. FIG. 10A illustrates an elevated overview of said front 408 comprising said window 802 and said flap 804. FIG. 10B illustrates a perspective overview of said one or more side portions of said monitor cover 700 with said front 408 unattached. FIG. 10C illustrates a perspective overview of said one or more side portions of said monitor cover 700 with said front 408 attaching. FIGS. 10D and 10E illustrate a perspective overview of said one or more side portions of said monitor cover 700 with said front 408 attached.

In one embodiment, front 408 with said flap 804 can comprise a first portion 1002 and said window 802. In one embodiment, said first portion 1002 can comprise central portion 614 and edge portion 616. In one embodiment, central portion 614 can comprise said flap 804. In one embodiment, said flap 804 can be cut from said first portion 1002 by cutting a bottom edge 1004, a first side edge 1006 and a second side edge 1008 from said central portion 614. In one embodiment, pulling up said flap 804 can comprise an aperture 1010. In one embodiment, window 802 can be attached under flap 804 to cover said aperture 1010. In another embodiment, window 802 can be eliminated to maintain aperture 1010 underneath said flap 804.

In one embodiment, attaching said front 408 with said flap 804 can be substantially the same as attaching said front 408 not having said flap 804, as disclosed infra.

FIG. 11 illustrates a perspective overview of a monitor cover 1100 and said monitor system 102. In one embodiment, monitor cover 1100 can comprise said monitor cover 300 with said back opening 412 in a bottom portion (rather than a back portion) of said monitor cover 1100.

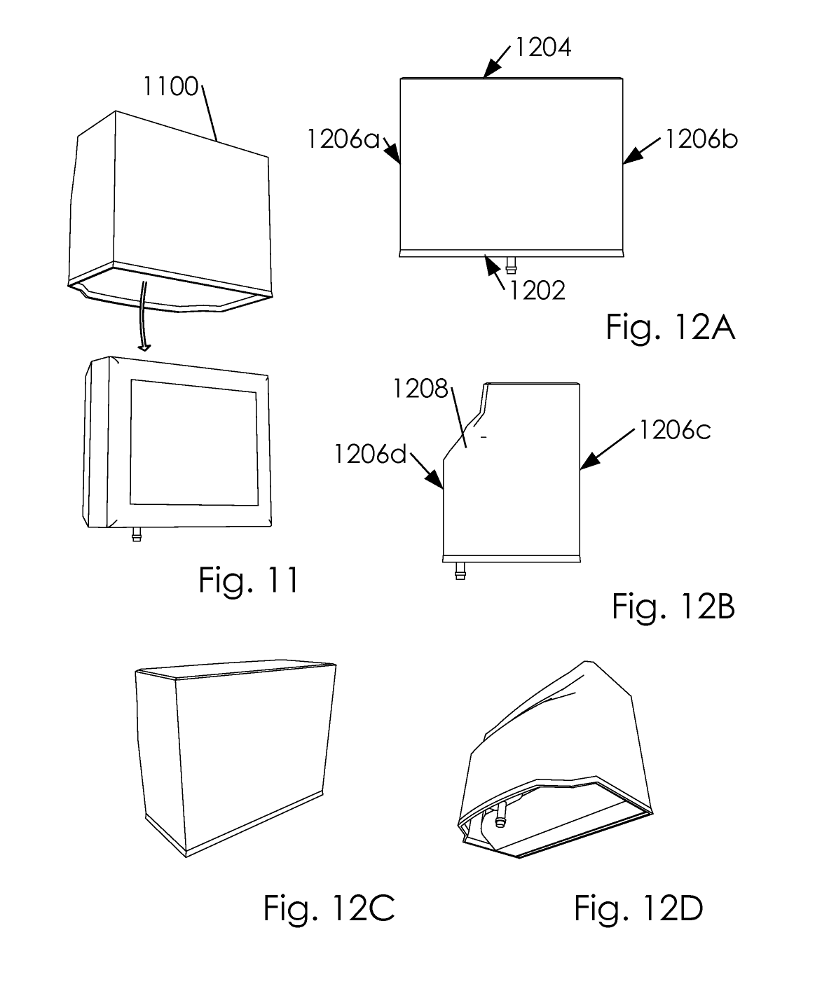

FIGS. 12A, 12B, 12C and 12D illustrate an elevated front view, and an elevated side view, a perspective overview and a perspective lower view of said monitor cover 1100 covering said monitor system 102. Monitor cover 1100 can comprise a bottom end 1202 and a top end 1204. Monitor cover 1100 can comprise a first side 1206a, a second side 1206b, a front side 1206c and a back side 1206d. In one embodiment, said bottom end 1202 can comprise an opening capable of receiving said monitor system 102.

In another embodiment, attaching said monitor cover 1100 to monitor system 102 can comprise: sliding said bottom end 1202 around a portion of said monitor system 102. In one embodiment, portion of said monitor system 102 covered by said monitor cover 1100 can comprise screen 104, front 208, back 210, first side edge 206a, second side edge 206b and/or top edge 206c. In one embodiment, monitor cover 1100 can also cover a portion of said mounting assembly 216 and said one or more wires 106. In one embodiment, monitor cover 1100 can comprise a bulge 1208 at said back side 1206d; wherein, said bulge 1208 comprises an expanded portion of said monitor cover 1100 capable of covering a portion of said mounting assembly 216 and/or said one or more wires 106.

In one embodiment, said system and method for protecting a screen can comprise a monitor cover (such as monitor cover 300, monitor cover 700, and/or monitor cover 1100) having a screen cover portion (such as front 408), an opening (such as back opening 412 and/or bottom end 1202), and said binding 414.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A monitor cover comprising:
a screen cover portion having a first side and a second side,
an opening, and
a binding; wherein,
said screen cover portion is capable of removably covering a screen of a monitor system,
said opening is capable of encompassing a portion of said monitor system, and
said binding is capable of holding said screen cover portion of said monitor cover over said portion of said monitor system.

2. Said monitor cover of claim 1 further comprising a one or more side portions having a first open end and a second open end; wherein,
said screen cover portion attaches to said first open end of said one or more side portions of said monitor cover, and
said opening comprises said second open end of said one or more side portions of said monitor cover.

3. Said monitor cover of claim 2 wherein said one or more side portions of said monitor cover comprise a substantially rectangular sleeve.

4. Said monitor cover of claim 3 wherein,
said one or more side portions of said monitor cover comprise a first side portion, a second side portion, a third side portion and a fourth side portion; and
said one or more side portions of said monitor cover comprises four parts of a uniform material.

5. Said monitor cover of claim 3 wherein said one or more side portions of said monitor cover and said screen cover portion comprise a canvas material.

6. Said monitor cover of claim 1 wherein said second side of said screen cover portion comprises a non-abrasive material capable of contacting said screen of said monitor system without scratching said screen.

7. Said monitor cover of claim 1 further comprising
a mounting assembly, a one or more wires, and a one or more vents attached to said monitor system; and
said monitor cover covers a portion of said monitor system without interfering with said mounting assembly, said one or more wires, and a portion of said one or more vents.

8. Said monitor cover of claim 1 further comprising a flap in said screen cover portion of said monitor cover.

9. Said monitor cover of claim 8 further comprising a window under said flap in said screen cover portion of said monitor cover.

10. Said monitor cover of claim 9 further comprising a flap catch capable of releasably holding said flap in a closed-configuration; wherein,
said monitor cover can comprise said closed-configuration and an open-configuration;
said closed-configuration comprises said flap covering said window; and
said open-configuration comprises said flap opened to expose said window.

11. Said monitor cover of claim 10 wherein
said flap catch comprises a first portion and a second portion, and
said first portion and said second portion releasably attach to one another.

12. Said monitor cover of claim 11 wherein said flap catch comprise a pair of magnets.

13. Said monitor cover of claim 11 wherein said flap catch comprise a hook-and-loop fastener assembly.

14. Said monitor cover of claim 1 wherein
said opening comprises a back opening in said monitor cover; and
attaching said monitor cover to said monitor system comprises:
stretching said binding and expanding said back opening,
sliding said back opening around a portion of said monitor system, and
releasing said binding.

15. Said monitor cover of claim 1 wherein
said opening comprises an opening in a bottom portion of said monitor cover; and
said opening is capable of sliding around a top portion of said monitor system.

16. A monitor covering method comprising attaching a monitor cover to a monitor system by
encompassing an opening of a monitor cover system around a portion of a monitor system, and
attaching said opening of said monitor cover around said monitor system.

17. The monitor covering method of claim 16 wherein attaching said opening of said monitor cover around said monitor system comprises:
stretching a binding of said monitor system around a portion of said monitor system;
further wherein,
said binding is attached around a circumference of said opening of said monitor cover, and
said binding is capable of stretching and contracting.

18. The monitor covering method of claim 16 wherein attaching said opening of said monitor cover around said monitor system comprises:
attaching one or more straps around said opening.

19. The monitor covering method of claim 16 further comprising:
opening a flap of said monitor cover to reveal a portion of said screen of a monitor system.

20. The monitor covering method of claim 19 further comprising:
releaseably closing said flap with a flap catch having a first portion and a second portion; wherein,
said first portion and said second portion of said flap catch are capable of releaseably connecting to one another.
